(19) United States
(12) Patent Application Publication
(10) Pub. No.: US 2025/0378460 A1
(43) Pub. Date: Dec. 11, 2025

(54) SYSTEM AND METHOD FOR COLLATERAL APPRAISAL AND LOAN ENTRY INTEGRATION

(71) Applicant: PORTER'S PAWN & BARGAIN CENTER INC., Mountain Home, AR (US)

(72) Inventors: Shane Porter, Mountain Home, AR (US); Jackson Bullard, Mountain Home, AR (US)

(21) Appl. No.: 19/228,192

(22) Filed: Jun. 4, 2025

Related U.S. Application Data
(60) Provisional application No. 63/657,436, filed on Jun. 7, 2024.

(51) Int. Cl. G06Q 30/0208; G06Q 30/02; G06Q 40/03; G06Q 50/18

(52) U.S. Cl. CPC G06Q 30/0208; G06Q 30/0278; G06Q 40/03; G06Q 50/188

(57) ABSTRACT

A system for collateral appraisal and loan entry integration is disclosed. The system allows a user to select an item to buy or pawn. The system obtains information of the item, accesses vast databases and utilizes machine learning algorithms to analyze various data points and generates accurate valuation for the item. The system assesses the value of the item based on location, recent sales transaction data, latest market information, etc., and ensures that the item valuation is current and accurate. Further, the system determines loan tenure or loan amount that can be provided to the user to pawn or buy the item. This automates the collateral valuation by leveraging technology and eliminates the need for manual appraisals.

### BACKGROUND OF THE INVENTION

### CROSS REFERENCE TO RELATED APPLICATIONS

The present application claims the benefit of U.S. Provisional Application No. 63/657,436 titled “SYSTEM AND METHOD FOR COLLATERAL APPRAISAL AND LOAN ENTRY INTEGRATION” and filed June 7, 2024; all of which is incorporated herein and referenced thereto.

### FIELD OF THE INVENTION

The present invention relates to processing information. More particularly, the present subject matter relates to a system and method for collateral appraisal and loan entry integration.

### DESCRIPTION OF THE PRIOR ART

Traditionally, loan or pawn processing procedures for items involve manual data entry and separate processes for collateral appraisal and loan application entry and processing. The items include, but not limited to, jewellery, electronics, watches, vehicles, art and collectibles, etc. Manual processing is time consuming, prone to errors and lacks transparency. With the advent of technology, several attempts were made to address the problems associated with the manual process. Many solutions try to automate the procedures for accepting or rejecting the items as collateral for loans, depending on the type of loan and/or policies of a lender.

One such example is disclosed in a United States Publication No. 20220253931, entitled “Computer system” (“the ‘931 Publication”). The ‘931 Publication discloses a computer-implemented method comprising, by one or more hardware computer processors configured with specific computer executable instructions, receiving a set of customer parameters representing characteristics of a customer, accessing a catalogue containing data on vehicles of a collection of vehicles to obtain vehicle parameters representing characteristics of specific vehicles of the collection of vehicles, generating deal data elements each representing a respective potential deal, each deal data element comprising an association between loan parameters and a vehicle of the collection of vehicles, operating a finance prediction AI on the deal data elements to predict responses of one or more lenders to the respective potential deals represented by the deal data elements for the customer, associating the deal data elements with evaluation scores representing evaluations of the respective potential deals according to an evaluation metric taking into account the predicted bank responses; and selecting a subset of the deal data elements based on the evaluation scores and displaying a visual representation of the respective potential deals represented by the subset of deal data elements on a display device.

Another example is disclosed in a PCT Publication No. 2021010614, entitled “Non-deposit collateral pawnshop automation system and method” (“the ‘614 Publication”). The ‘614 Publication discloses a non-deposit collateral pawnshop automation system and method which enable a non-visit non-face-to-face collateral loan by means of non-deposit collateral, the non-deposit collateral pawnshop automation system comprising: a collateral value assessment module for receiving at least one collateral image and collateral input information by means of a client terminal and then assessing the value of collateral on the basis thereof; a borrowing client identification information verification module for receiving an identification card image of a borrowing client and input information of the borrowing client by means of the client terminal and then verifying the identification information of the borrowing client on the basis thereof; a loan account real name inquiry module for receiving loan-receiving account information of the borrowing client by means of the client terminal and then verifying the real name in the account information of the borrowing client on the basis thereof; a borrowing client/account match verification module for determining whether or not there is a match by comparing the verified identification information of the borrowing client with the identification of the loan account of which the real name has been verified; a good faith obligation of collateral guide/agreement module for, if the match is determined by means of the borrowing client/account match verification module, confirming the validity of both the image and information of the collateral received from the client terminal and, if the validity cannot be confirmed, transmitting a warning statement notifying a civil and penal liability to the client terminal and then receiving a response thereto; and a loan contract module for generating collateral loan contract information comprising a loan range, loan period and interest rate on the basis of the collateral value assessment by the collateral value assessment module and then providing same to the client terminal and receiving and storing client agreement information in accordance with same.

Yet another example is disclosed in a United States Publication No. 20220366491, entitled “Incrementally perfected digital asset collateral wallet” (“the ‘491 Publication”). The ‘491 Publication discloses a multisig digital asset wallet storing collateral for a loan between a borrower and a lender. The borrower and lender agree to loan terms including collateralization requirements. Over the course of the loan repayment period, a Loan-to-Value (LTV) ratio between the digital asset collateral and the loan principal balance will change due to fluctuations in the market exchange value of the digital asset and a declining loan principal balance due to regular loan repayments by the borrower. If the LTV exceeds the collateral requirements by an overage amount, then the borrower may sign a transaction and request signatures from other participants to withdraw funds from the multisig collateral wallet. If the LTV fails to satisfy the collateral requirements, participants may spend funds from the multisig collateral wallet to improve the LTV, catch up after a missed payment by the borrower, or pay down the loan principal.

Although the above discussed disclosures are useful, most of them provide inconsistent valuations due to inadequate data or involvement of manual procedures, and involve time-consuming appraisals.

Therefore, there is a need in the art to provide an improved system and method for collateral appraisal and loan entry integration.

### SUMMARY OF THE INVENTION

It is one of the main object of the present subject matter to provide a system for collateral appraisal and loan entry integration that avoids the drawbacks of the prior art.

It is another object of the present subject matter to provide a system that automates the collateral valuation by leveraging technology and eliminates the need for manual appraisals and loan entries.

In order to overcome the limitations here stated, the present subject matter provides a system for collateral appraisal and loan entry integration. The system allows a user to select an item to buy or pawn. The system obtains information of the item, accesses vast databases and utilizes machine learning algorithms to analyse various data points and generates accurate valuation for the item. The system assesses the value of the item based on location, recent sales transaction data, latest market information, etc., and ensures that the item valuation is current and accurate. Further, the system determines loan tenure or loan amount that can be provided to the user to pawn or buy the item.

In one aspect of the present subject matter, the system keeps track of anomalous events. The anomalous events include, but not limited to, overriding by users or employees to artificially change the description of the item, images, data corresponding to the item, loan amount, loan tenure, etc.

In one advantageous feature of the present subject matter, the system considers previous sale prices, customer history and current inventory i.e., merchandise and collateral for determining valuation for the item. The system provides automatic and real-time reports to users on client devices to make informed decisions.

In another one advantageous feature of the present subject matter, the system keeps track of the item in the inventory and updates the data in real-time. The system helps to determine business-trends such as item-specific loan amounts, product/item trend, etc.

In another advantageous feature of the present subject matter, the system allows to view current loans and any upcoming renewals. Further, the system allows the user to browse merchandise available and request for additional photos to make informed decisions.

In another advantageous feature of the present subject matter, the system reduces redundant data entry by accessing various databases and utilizing machine learning algorithms to analyse various data points. This helps to generate accurate valuation for the item. The data is then used to integrate the loan information that can be extended to the user.

Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

FIG. 1 is an exemplary network communications system, in accordance with one embodiment of present subject matter.

FIG. 2 is a diagrammatic representation of the system, in accordance with one embodiment of present subject matter.

FIG. 3 is a block diagram of a host device, in accordance with one embodiment of the subject matter.

FIG. 4 is a workflow of collateral appraisal and loan entry integration, in accordance with one embodiment of the subject matter.

FIG. 5 is a method of the collateral appraisal and loan entry integration, in accordance with one embodiment of the subject matter.

### DETAILED DESCRIPTION OF THE PREFERRED EMBODIMENT

The following detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed subject matter. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed subject matter.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

Various features and embodiments of a subject matter are explained in conjunction with the description of FIGUREs (FIGs) 1-5.

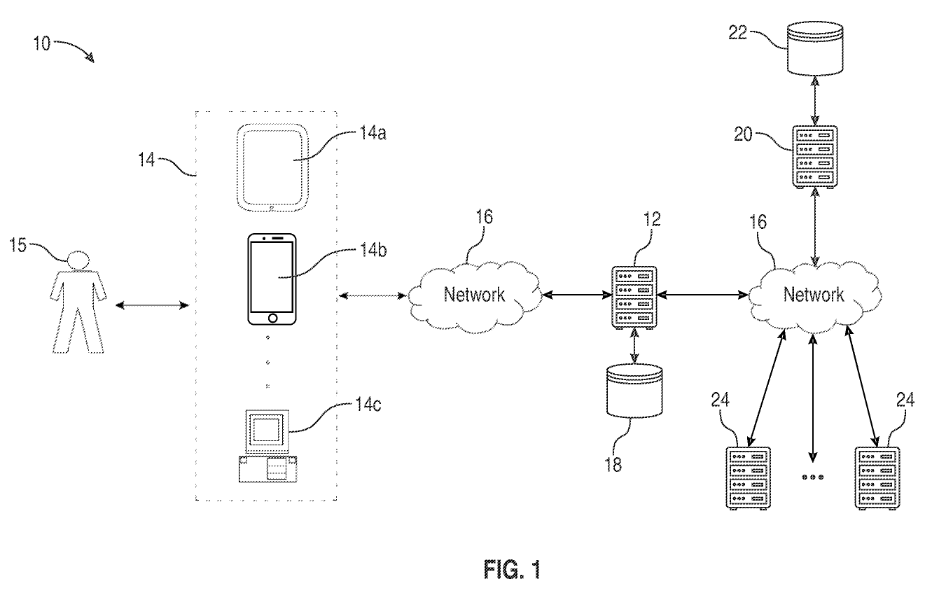

The present subject matter discloses a system for collateral appraisal and loan entry integration. The system may be realised in a network communications system. FIG. 1 shows a high-level block diagram of an exemplary network communications system 10, such as a client-server environment having a system 12. In one example, system 12 indicates an application server (or app server). In one example, system 12 is operated by an e-commerce service provider that lists used and/or new items. System 12 communicatively connects to one or more client devices such as client device 14a, client device 14b… client device 14c, collectively referred as client devices or simply client device 14. Client device 14 indicates an electronic device such as a mobile device, a personal digital assistant, a laptop computer, a tablet computer, a desktop computer etc. In the present subject matter, a user 15 operates client device 14. In one example, user 15 indicates a lender appraising the item. Optionally, user 15 indicates an individual/lendee in search of pawning or buying.

The item includes, but not limited to, jewellery, electronics, watches, vehicles, art and collectibles, etc.

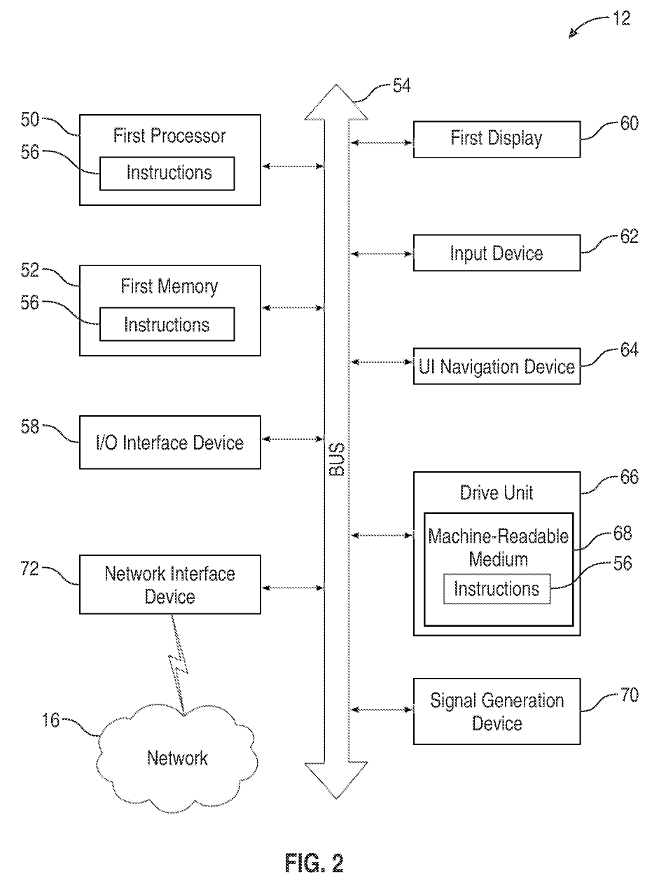

FIG. 2 shows a diagrammatic representation of system 12, in accordance with one embodiment of present subject matter. System 12 encompasses a first processor 50 (e.g., a central processing unit (CPU), a graphics processing unit (GPU) or both). First processor 50 electrically couples by a data bus 54 to a first memory 52. First memory 52 includes a volatile memory and/or a non-volatile memory. Preferably, first memory 52 stores instructions or software program 56 that interact with the other devices in client device 14 and/or host devices 20, 22 as described below. In one implementation, first processor 50 executes instructions 56 stored in first memory 52 in any suitable manner. In one implementation, first memory 52 stores digital data indicative of documents, files, programs, web pages, etc. retrieved from one of client device 14, and/or host devices 20, 22.

System 12 further includes an input/Output (I/O) interface device 58, a first display 60 (e.g., a liquid crystal display (LCD) or a cathode ray tube (CRT)). System 12 includes an input device (e.g., a keyboard) and/or a touchscreen 62, a user interface (UI) navigation device 64 (e.g., a mouse), a drive unit 66, a signal generation device 70 (e.g., a speaker) and a network interface device 72.

Drive unit 66 includes a machine-readable medium 68 on which one or more sets of instructions and data structures (e.g., software 56) is stored. It should be understood that the term “machine-readable medium” includes a single medium or multiple medium (e.g., a centralised or distributed database, and/or associated caches and servers) that stores one or more sets of instructions. The term “machine-readable medium” also includes any medium that is capable of storing, encoding or carrying a set of instructions for execution by the machine and that cause the machine to perform any one or more of the methodologies of the present subject matter, or that is capable of storing, encoding or carrying data structures utilised by or associated with such a set of instructions. The term “machine-readable medium” accordingly includes, but not be limited to, solid-state memories, optical and magnetic media, and carrier wave signals.

Instructions 56 reside, completely or at least partially, within first memory 52 and/or within first processor 50 during execution thereof by system 12. Network interface device 72 transmits or receives instructions 56 over network 16 utilising any one of a number of well-known transfer protocols.

Network 16 includes a wireless network, a wired network or a combination thereof. Network 16 can be implemented as one of the different types of networks, such as intranet, local area network (LAN), wide area network (WAN), the internet, and the like. Network 16 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 16 includes a variety of network devices, including routers, bridges, servers, computing devices, storage devices, and the like.

System 12 further connects to a first database 18. First database 18 indicates an application database. In one example, first database 18 stores information such as lendee history, transaction history, etc. The lendee history includes loan renewals, redemptions, etc. The transaction history includes price at which an item was sold, redemption ratios by collateral type, item type pawn/sell volume by the time of year, etc. Further, system 12 communicates with one or more host devices 20, 24 via network 16. In one implementation, each host device 20, 24 indicates an electronic device such as a mobile device, a personal digital assistant, a laptop computer, a tablet computer, a desktop computer etc. Host devices 20, 24 indicate a third party server or application program interface (API) managers that store one or more of a plurality of files, programs, interfaces, databases, and/or web pages in one or more memories for use by system 12, or client devices 14. In one example, host devices 20, 24 stores applications, memory, hardware, etc., and provides various options for collateral appraisal and loan entry integration. Here, system 12 receives information from client device 14 and performs various administrative tasks and enables it to execute and operate applications, memory, hardware, etc. for collateral appraisal and loan entry integration by retrieving data from host devices 20, 24 via network 16.

In one example, host device 20 includes an electronic commerce (e-commerce) API. Here, host device 20 communicatively connects to a second database 22. Second database 22 indicates an e-commerce database, such as eBay^{TM}, Gunbroker^{TM}, etc., having transaction histories for used and/or new items. Further, host device 24 includes APIs curated manually or using Artificial Intelligence (AI) techniques. It should be understood that any number of machine learning (ML) techniques and/or AI techniques can be used to provide the required number of APIs for use with system 12. In some examples, an unsupervised ML can be used to find correlation data relevant to loaning/pawning.

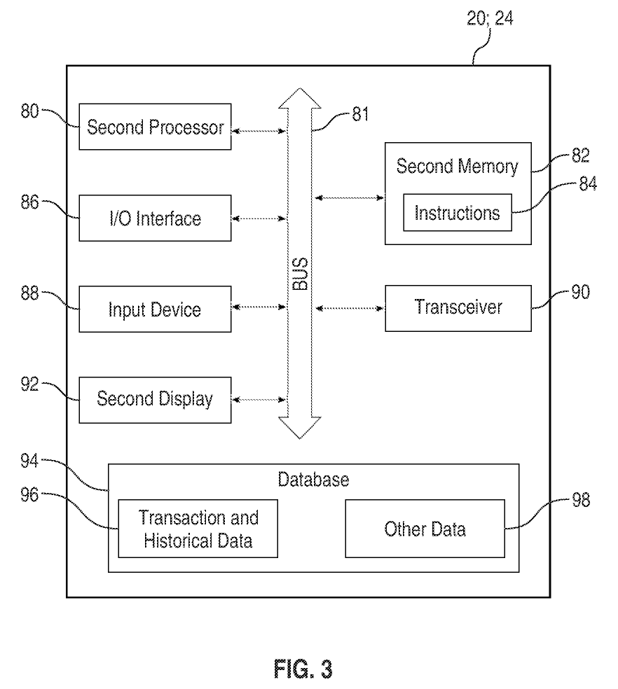

FIG.3 illustrates a block diagram of host devices 20, 24 illustrated in FIG. 1, in accordance with one embodiment of the present subject matter. Host devices 20, 24 encompasses a second processor 80 (e.g., a central processing unit (CPU), a graphics processing unit (GPU) or both). Second processor 80 electrically couples by a data bus 81 to a second memory 82. Second memory 82 includes a volatile memory and non-volatile memory. Preferably, second memory 82 stores instructions or software program 84 that interact with the other devices such as system 12, for example. In one implementation, second processor 80 executes instructions 84 stored in second memory 82 in any suitable manner. In one implementation, second memory 82 stores digital data indicative of documents, files, programs, web pages, etc.

Host devices 20, 24 further includes an input/output (I/O) interface 86, an input device (e.g., a keyboard) and/or a touchscreen 88, a transceiver 90 and a second display 92 (e.g., a liquid crystal display (LCD) or a cathode ray tube (CRT)). Transceiver 90 transmits or receives instructions 84 over network 16 utilising any one of a number of well-known transfer protocols.

Each of host devices 20, 24 includes a database 94. Database 94 indicates data structure configured for storing information. In the current embodiment, database 94 includes transactional and historical data 96, and other data 98. Transactional and historical data 96 includes data corresponding to the same or similar transactions, customer history, price information, historical price of items, information of service providers, date of transactions, events affecting the price, terms and conditions of pawn or loan of the items.

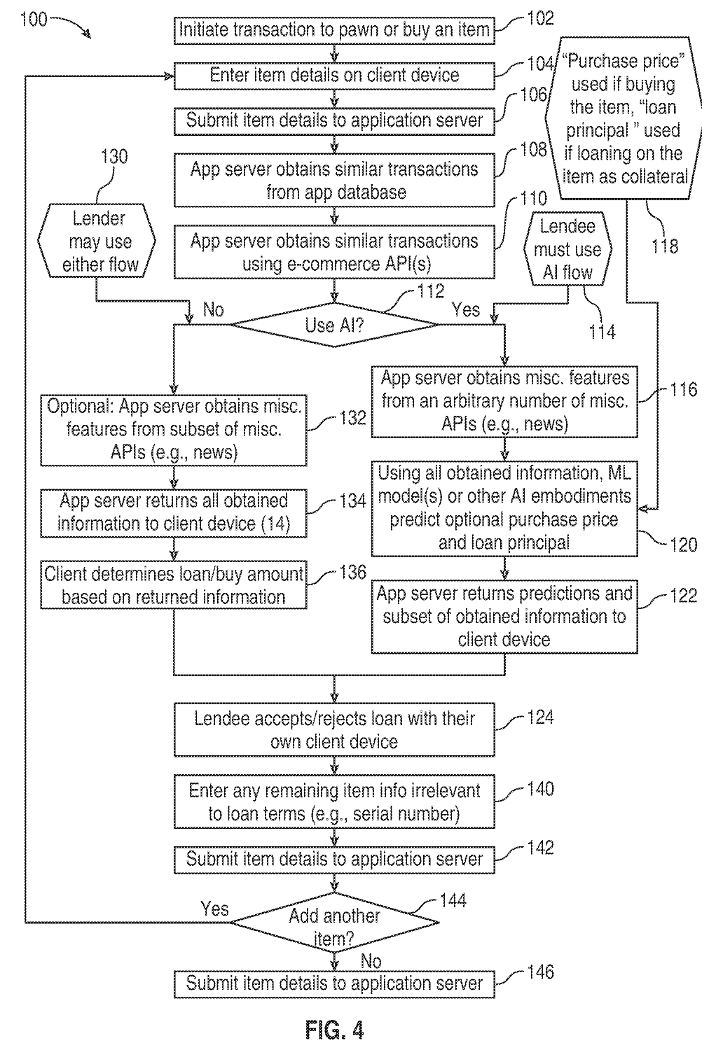

Now referring to FIG. 4, a workflow 100 of collateral appraisal and loan entry integration is explained, in accordance with one exemplary embodiment of the present subject matter. The order in which workflow 100 is described should not be construed as a limitation, and any number of the described method blocks can be combined in any order to implement workflow 100 or alternate methods. Additionally, individual blocks may be deleted from workflow 100 without departing from the spirit and scope of the subject matter described herein. Furthermore, workflow 100 can be implemented in any suitable hardware, software, firmware, or combination thereof. However, for ease of explanation, in the embodiments described below, workflow 100 may be implemented using the above-described system 12.

At first, user 15 registers client device 14 with system 12. In one example, user 15 provides his/her name, address, social security number, etc., to register with system 12. System 12 verifies the information provided by user 15 and creates a profile with a unique identification number. The profile includes user details, loan information such as current loans, renewal details, items purchased, etc.

Workflow 100 starts at step 102. At step 102, user 15 initiates a transaction to either pawn or buy an item. As specified above, the item includes, but not limited to, jewellery, electronics, watches, vehicles, art and collectibles, etc. In one example, user 15 browses the items/merchandise presented to him/her by system 12 on his/her client device 14. Optionally, user 15 requests photos of the items to obtain more information about the item.

At step 104, user 15 inputs item details via client device 14. At step 106, user 15 submits the details of the item to system/application server 12. In one example, consider the item selected is jewellery, then system 12 obtains information such as make/manufacturer, model, serial number or any other information to properly identify the item. At step 108, system 12 obtains similar transaction details from first database 18 (application database or app database). Further, system 12 obtains similar transaction details from host devices 20 (e-commerce APIs), as shown at step 110. At step 112, system 12 checks whether it is required to use AI to obtain the loan/pawn information corresponding to the item. If required, user 15 uses AI to obtain information from different APIs, as shown at step 114. At step 116, system 12 obtains information from host device 24 such as any information that is relevant to the item. The information includes, but not limited to, news events, price, commodity pricing, etc., that can be leveraged by system 12 to better estimate collateral value. In one example, system 12 obtains information such as “purchase price” used for buying the item, “loan principal” used if loaning on the item as collateral, as shown at step 118. Subsequently, system 12 uses all the obtained information from step 116 and step 118, uses ML models or other means to predict optimal purchase price and loan principal, as shown at step 120. Further, system 12 predicts and provides a subset of information obtained to client device 14, as shown at step 122. Subsequently, workflow 100 moves to step 124.

At step 112, if system 12 determines that AI is not needed, then user i.e., lendee 15 may use manual or AI workflow (step 130). Here, system 12 obtains information from host device 24 such as any information that is relevant to the item, as shown at step 132. Further, system 12 provides a subset of information obtained to client device 14, as shown at step 134. Subsequently, user or client 15 determines loan/buy amount based on the information provided by system 12, as shown at step 136. Subsequently, workflow 100 moves to step 124.

At step 124, user or lender 15 accepts or rejects the loan using client device 14. At step 140, user 15 enters any remaining item information relevant/irrelevant to the loan terms such as a serial number, for example. At step 144, system 12 checks if user 15 has added another item to the cart. If user 15 adds another item, then workflow 100 moves to step 104. If user 15 does not add another item to the cart, then workflow 100 moves to step 144. Workflow 100 ends at step 144.

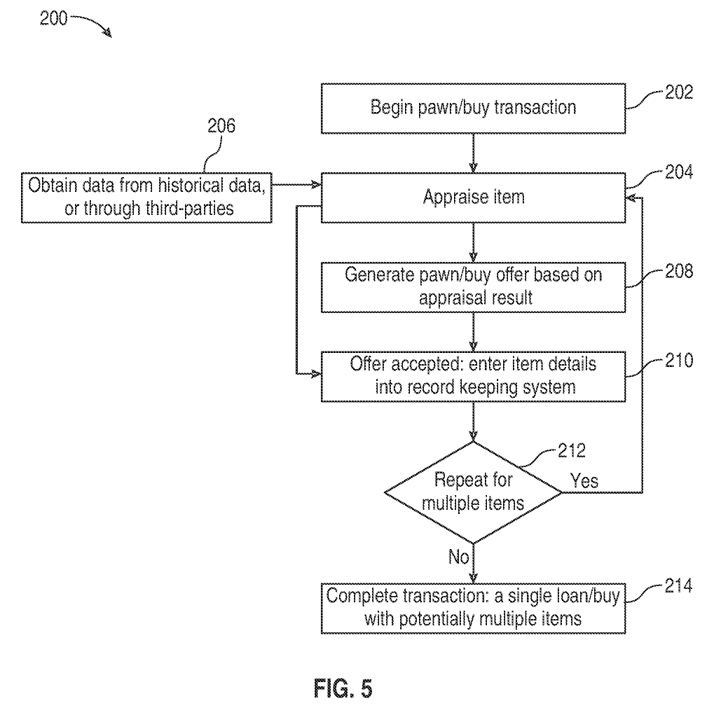

Now referring to FIG. 5, a method 200 of collateral appraisal and loan entry integration is explained, in accordance with one exemplary embodiment of the present subject matter. The order in which method 200 is described should not be construed as a limitation, and any number of the described method blocks can be combined in any order to implement method 200 or alternate methods. Additionally, individual blocks may be deleted from method 200 without departing from the spirit and scope of the subject matter described herein. Furthermore, method 200 can be implemented in any suitable hardware, software, firmware, or combination thereof. However, for ease of explanation, in the embodiments described below, method 200 may be implemented using the above-described system 12.

Method 200 starts at step 202. At step 202, user 15 initiates a transaction to either pawn or buy an item. At step 204, system 12 appraises the item. In order to appraise the item, system 12 retrieves the data needed for appraisal using one or more third-party APIs, as shown at step 206. Further, system 12 returns the data to the user and/or feeds to predictive AI. In one example, system 12 stores all the data processed and acts as a recordkeeping system such that the information processed once can be used later any number of times, if the data is relevant. This way, system 12 avoids redundant item descriptor entries while providing a single point of access to all information necessary for appraisal.

In addition, system 12 uses lender’s historical data and aggregated data from across databases 18, 20, 22, 24 to provide additional information relevant to the appraisal at step 204. In one example, system 12 obtains the information either directly from the user or obtains through predictive AI alongside the third-party API results.

At step 208, system 12 generates a pawn/buy offer to user 15 based on the appraisal result at step 204. At step 210, if user 15 accepts the offer, then item details are provided to system 12. At step 212, system 12 checks if the process has to be repeated for adding additional items. If yes, then method 200 moves to step 204. If no items have to be added to the cart, the method 200 moves to step 214. At step 214, system 12 completes the transaction with a single loan/buy with potentially multiple items. Method 200 ends at step 214.

Based on the above, it is evident that the presently disclosed system automates the collateral valuation and loan entry by leveraging technology. The system accesses vast databases and utilizes machine learning algorithms to analyse various data points and generates accurate valuations. As a result, the system eliminates the need for manual appraisals and data entries. For example, the system assesses the value of the item to pawn or buy based on location, recent sales transaction data, latest market information, etc., and ensures that the item valuation is current and accurate.

The present subject matter has been described in particular detail with respect to various possible embodiments, and those of skill in the art will appreciate that the subject matter may be practiced in other embodiments. First, the particular naming of the components, capitalization of terms, the attributes, data structures, or any other programming or structural aspect is not mandatory or significant, and the mechanisms that implement the subject matter or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present subject matter in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present subject matter include process steps and instructions described herein in the form of an algorithm. It should be noted that the process steps and instructions of the present subject matter could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skilled in the, along with equivalent variations. In addition, the present subject matter is not described with reference to any particular programming language. It is appreciated that a variety of programming languages may be used to implement the teachings of the present subject matter as described herein, and any references to specific languages are provided for disclosure of enablement and best mode of the present subject matter.

It should be understood that components shown in FIGUREs are provided for illustrative purposes only and should not be construed in a limited sense. A person skilled in the art will appreciate alternate components that may be used to implement the embodiments of the present subject matter and such implementations will be within the scope of the present subject matter.

While preferred embodiments have been described above and illustrated in the accompanying drawings, it will be evident to those skilled in the art that modifications may be made without departing from this subject matter. Such modifications are considered as possible variants included in the scope of the subject matter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for collateral appraisal and loan entry integration, comprising: a server configured to operate a collateral appraisal and loan entry platform; a network communicatively coupling the server to one or more user devices and one or more host devices; the server comprising: a processor; a memory storing a set of instructions executable by the processor, wherein the instructions, when executed, configure the server to: receive, from the one or more user devices, a request to initiate a transaction for at least one of: pawning and buying an item; obtain information corresponding to the item; determine a valuation for the item based on the obtained information; determine a loan amount and loan tenure based on the valuation of the item; provide a user interface to the user device to display the item information, valuation, loan amount, and loan tenure; receive confirmation from the one or more user devices to proceed with a transaction based on the valuation, loan amount, and loan tenure; and complete the transaction by at least one of: pawning and selling the item.

2. The system of claim 1, wherein the server is configured to determine the valuation of the item by accessing one or more external data sources via the host devices.

3. The system of claim 2, wherein the external data sources comprise at least one of: previous sales transaction data, customer history data, inventory data, creditworthiness information, and market data.

4. The system of claim 1, wherein the server is configured to determine whether research is required for the item and, when required, conduct research using an artificial intelligence (Al) or machine learning (ML) model.

5. The system of claim 4, wherein the Al or ML model is configured to analyze at least one of: make, model, category, previous sales, customer history, market data, and creditworthiness information.

6. The system of claim 1, wherein the server is further configured to populate a cart with the item information, valuation, loan amount, and loan tenure, and allow the user to modify the cart.

7. The system of claim 1, wherein the server is further configured to generate real- time reports and send the reports to the one or more user devices.

8. The system of claim 1, wherein the server is further configured to detect anomalous events in the transaction data and generate an alert when an anomalous event is detected.

9. The system of claim 8, wherein an anomalous event comprises at least one of: a user modifying item information, changing loan terms beyond a threshold, andoverriding system-generated valuations.

10. The system of claim 1, wherein the server is configured to integrate with an external financial application, wherein the external financial application comprises an accounting software platform.

11. The system of claim 1, wherein the server is configured to track inventory data,including item-specific location and availability within one or more storage locations.

12. The system of claim 1, wherein the server is configured to generate business analytics reports across multiple store locations.

13. The system of claim 1, wherein the server is configured to provide a consumer- facing interface via the user device, allowing the user to view, renew, and repay existing loans.

14. The system of claim 13, wherein the consumer-facing interface further allows the user to browse available merchandise and request photos of items.

15. The system of claim 1, wherein the server is configured to store and retrieve transaction data and historical data in a database communicatively coupled to the server.

16. A method for collateral appraisal and loan entry integration, comprising:receiving, from a user device via a network, a request to initiate a transaction for at least one of: pawning and buying an item;obtaining information corresponding to the item;determining a valuation for the item based on the obtained information;determining a loan amount and a loan tenure for the item based on the valuation;providing a user interface to the user device to display the item information,valuation, loan amount, and loan tenure;receiving confirmation from the user device to proceed with a transaction based on the valuation, loan amount, and loan tenure; andcompleting the transaction by at least one of: pawning and selling the item.

17. The method of claim 16, further comprising determining whether research is required for the item, and when research is required, conducting research using an artificial intelligence (Al) or machine learning (ML) model.

18. The method of claim 17, wherein conducting research using the Al or ML model comprises analyzing at least one of: make, model, category, previous sales,customer history, market data, and creditworthiness information.

19. The method of claim 16, wherein obtaining information corresponding to the item comprises querying one or more external data sources via one or more host devices.

20. The method of claim 16, further comprising detecting anomalous events in the transaction data and generating an alert when an anomalous event is detected.
